(19) United States
(12) Patent Application Publication
(10) Pub. No.: US 2004/0206612 A1
(43) Pub. Date: Oct. 21, 2004

(54) Timer

(76) Inventors: Gavin Melia, Wagram, NC (US); Renee Gustafson, Pinehurst, NC (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/417,044

(22) Filed: Apr. 16, 2003

(51) Int. Cl. G04F 10/00; G04F 8/00

(52) U.S. Cl. 200/36

(57) ABSTRACT

A timer with a setting ring. The timer comprises a body having a length with a first end wall and a second end wall and a setting ring. The setting ring is engaged with a portion of the body and is configured to rotate around an axis of rotation extending through the body. The axis of rotation is parallel to the length of the body and generally perpendicular to the first and second end walls. Additionally, the timer comprises a plurality of tappets. The plurality of tappets are positioned around and engaged with the setting ring, wherein the plurality of tappets move between a first position and a second position within the setting ring in a direction parallel to the axis of rotation.

### BACKGROUND OF THE INVENTION

The present invention relates to electromechanical timers. In particular, the present invention relates to a programmable timer, and more particularly to a programmable timer which may be set to control, automatically, the operation of electrical devices a plurality of times during a time interval, such as a twenty-four hour time interval.

Timers are accessory appliances used in households and businesses. One type of conventional timer plugs into an electrical receptacle and provides a switched electrical receptacle into which another appliance, the controlled appliance, such as a lamp, radio, etc., can be plugged. The timer includes an internal switch that is connected to the electrical receptacle provided on the timer, wherein the timer automatically turns the appliance on and off via the switch.

Turning appliances “on” and “off” at selected times is desirable for a variety of reasons. One particular reason important to absent home owners is to simulate normal activities of the household for safety and security reasons by having appliances, such as lights, turned on and off while they are not there.

Referring to FIG. 1, a conventional prior art timer 12 comprises a housing 14 having a face plate 16 with time of day indicating indicia 18 displayed thereabout. Adjacent to the time indicia 18 are a plurality of buttons 20 which are each selectively movable between “off” and “on” positions around a dial 22. The dial 22 is mounted in the housing 14 so that it is rotatable thereto. Typically, the dial 22 is mounted in a circular recess in the front 24 of the housing 14. The diameter of the circular recess is larger than the diameter of the dial 22 so that a circular channel is defined around the outside circumference of the dial 22.

The indicia 18 typically indicate time periods such as the 24 hours of the day. The indicia 18 may range from “01:00” to “24:00” or the dial 22 may be divided into two halves, representing “A.M.” and “P.M.”, with each of the halves numbered from “1” to “12.” The A.M. and P.M. halves may be distinctively marked, by means of shading for example, to permit a user to readily distinguish the A.M. half of the scale from the P.M. half of the time scale.

The user sets the times by positioning the buttons 20 which connect with the internal switch of the conventional timer 12 to automatically turn on and off the electrical supply to the appliance plugged into the timer electrical receptacle 26. Conventional timers 12 include various interfaces to set the desired switching times. For example, on some timers, the user sets pins with tabs around the periphery of a dial to indicate the desired switching times. Other timers use sliding tabs around the periphery of the dial.

In conventional timers 12, the plug 28 mates with the wall socket 30 to face the dial 22 toward the user, i.e., the dial 22 lies in a plane parallel to a face of the wall socket 30. Accordingly, an axis of rotation 32 of the dial 22 is perpendicular to the front 24 of the housing 14. As such, the axis of rotation 32 is parallel to the top wall 34 and bottom wall 36 of the timer 12. Additionally, the plug 28 extends parallel to the axis of rotation 32. Thus, the plane of the dial 22 is perpendicular to the extent of the plug 28. Further, the buttons 20 move perpendicular to the axis of rotation 32.

Accordingly, in conventional timers, the plane of the dial is parallel to the plane of the wall for full display to the user. A problem with current timers, however, is the aesthetic appeal of the timer. Due to the dial being formed on the housing and displayed parallel with the wall, the timer prominently displays the dial to the user. Accordingly, the indicia of the dial stands out to disrupt the decor of the room. Thus, to avoid this, the user must try to camouflage the timer. Another problem with current timers, from a marketing perspective, is the similar structure or appearance of available timers.

A need, therefore, exists for a new timer to allow a user to minimize the visual impact of the timer. The solution, however, must be capable of allowing the user to conveniently set the required timed periods. Further, the solution must be capable of allowing the user to read the selected time periods to eliminate confusion as to the time the controlled appliance is to be turned “off” and “on.” Additionally, the solution must be capable of allowing the user to conveniently set a plurality of time periods in a cycle of time, such as a twenty-four hour period. A need also exists for a timer with new marketing appeal. The solution, however, must be economically viable. Timers currently available use a front display dial. As such, these timers fail to meet the current need since the front dial is unappealing to the user.

### SUMMARY OF THE INVENTION

The present invention provides for an electro-mechanical timer, in particular, an electro-mechanical timer that is constructed differently than current timers. To that end, the invention provides a timer that minimizes the visual impact of the timer.

Described in the accompanying drawings and following text is a new structure for a timer. This configuration leads to improved aesthetic and marketing characteristics. Thus, the invention disclosed herein provides a timer which overcomes many of the inadequacies of timers known in the art.

In an embodiment, the device comprises a body having a length with a first end wall and a second end wall and a setting ring. The setting ring is engaged with a portion of the body and is configured to rotate around an axis of rotation extending through the body wherein the axis of rotation is parallel to the length of the body. Additionally, the timer comprises a plurality of tappets. The plurality of tappets are positioned around and engaged with the setting ring, wherein the plurality of tappets can be moved between a first position and a second position within the setting ring in a direction parallel to the axis of rotation.

In an embodiment, the device comprises a body having a length with a first end wall and a second end wall and a setting ring. The setting ring is engaged with a portion of the body and is configured to rotate around an axis of rotation extending through the body. The axis of rotation is parallel to the length of the body and perpendicular to the first end wall and the second end wall. Additionally, the timer comprises a plurality of tappets. The plurality of tappets are positioned around and engaged with the setting ring and move in a direction parallel to the axis of rotation. Additionally, the embodiment comprises a cover positioned around the body, wherein the cover is movable over the setting ring to obscure the setting ring.

An advantage of the present invention is that it allows the user to easily set required time periods.

Another advantage of the present invention is that it allows the user to minimize the visual impact of the timer.

Another advantage of the present invention is that it provides the user with a structure visually distinguishable from other available timers.

A

### BRIEF DESCRIPTION OF THE DRAWINGS

FIG. 1 is a side perspective view of a conventional timer.

FIG. 2 is a side elevational view of a timer embodying the principles of the present invention.

FIG. 3 is a side elevational view of an embodiment of the present invention with a cover and with the setting ring exposed.

FIG. 4 is a view of the embodiment of FIG. 3 with the cover positioned to obscure the setting ring.

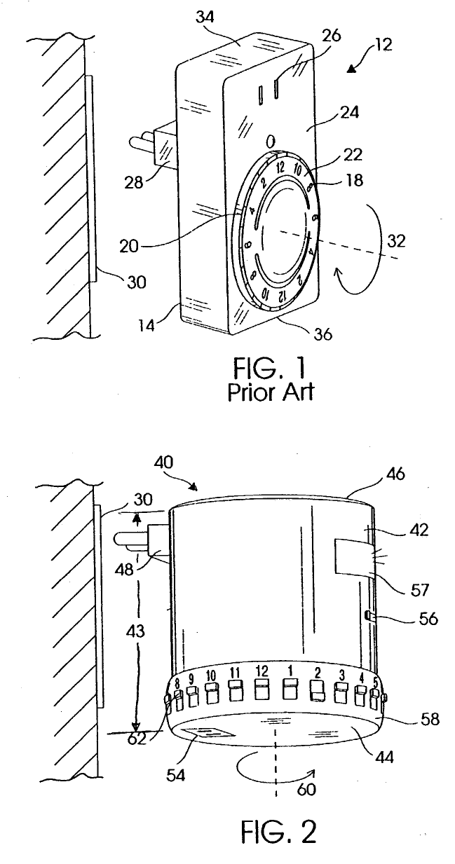

### DETAILED DESCRIPTION OF THE PREFERRED EMBODIMENTS

As discussed above, the present invention provides improved and varied structures and other accommodations for an electro-mechanical timer. The present invention provides an aesthetically enhanced appearance of a timer. The present invention also allows a user to conveniently set and control the timer.

The apparatus of this invention includes certain conventional components, including motors, gear trains and electrical contacts, and the details of which, although not fully illustrated or described, will be apparent to those having skill in the art and an understanding of the necessary function of such components.

FIG. 2 illustrates a side elevational view of a timer 40 embodying the principles of the present invention. The timer 40 comprises a body 42 having a length 43 and a first end wall 44 and a second end wall 46 wherein a plug 48 extends outward perpendicular to the length 43 of the body 42. The plug 48, however, may extend from the first end wall 44 or the second end wall 46, parallel to the length 43 of the body 42. As is known, the plug 48 mates with the wall socket 30. Additionally, a receptacle 54 may be positioned within the end wall 44. Further, a manual override switch 56 and an electro-luminescent light 57 are also positioned on the body 42. Although the body 42 is shown as being cylindrical along the entire length 43, other configurations may be used for the body 42.

A setting ring 58 is associated with a portion 45 of the body 42. The setting ring 58 is configured to rotate around an axis of rotation 60 which extends through the body 42 as illustrated in FIG. 2. The setting ring 58 generally surrounds at least a part of the portion 45 of the body and may rotate in either a clockwise or counterclockwise direction around the body 42.

The setting ring 58 further positions tappets 62 around the body 42. The tappets 62 move up and down (in the orientation shown in FIG. 2) within the setting ring 58 to set the proper “off” and “on” timer settings.

As configured, the axis of rotation 60 extends parallel to the length 43 of the body 42. Accordingly, the axis of rotation 60 extends substantially perpendicular to both the first end wall 44 and the second end wall 46. The plug 48, in turn, extends perpendicular to the axis of rotation 60. Additionally, the setting ring 58 rotates in a plane parallel to the direction that the plug 48 extends. Still further, the tappets 62 move in a direction parallel to the axis of rotation 60. Accordingly, the tappets 62 move parallel to the length 43 of the body 42.

Because the setting ring 58 and the associated tappets 62 may be positioned near the first end wall 44 of the body 42, the timer 40 maintains an appearance mostly free of any controls or prominent characteristics. Accordingly, the body 42 minimizes the visual impact of the timer 40 to present a more appealing blend with the existing decor of the room.

The setting ring 58, though, still provides convenient access for setting the desired “off” and “on” times. Since the setting ring 58 rotates, the user simply moves the setting ring 58 to a convenient position to display the appropriate tappet 62 for setting the required times. In an embodiment, the setting ring 58 may be disengaged from the internal component of the timer 40 to assist in manually rotating the setting ring 58 for displaying the appropriate tappet 62.

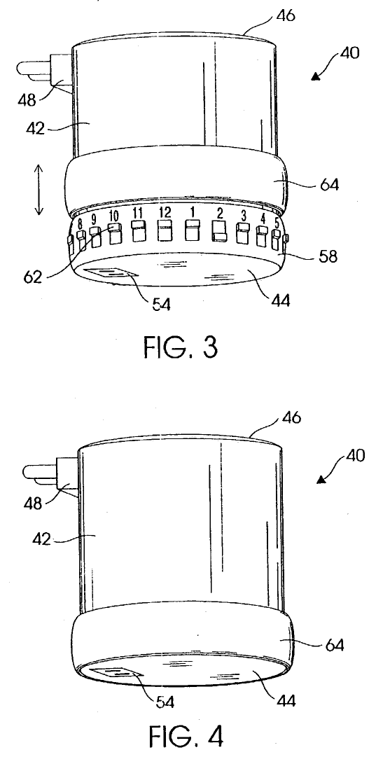

Turning to FIG. 3, another embodiment is shown. In this embodiment, the timer 40 includes a cover 64 positioned around the body 42 wherein the cover 64 moves with respect to the body 42 and in a direction parallel to the length 43 of the body 42. As shown in FIG. 4, the cover 64 is movable over the setting ring 58. Accordingly, in this embodiment, the cover 64 may obscure the setting ring 58 and the associated tappets 62 to minimize the visual impact of the timer 40. A lip, reinforcing rib or stop (not shown) may be positioned on the body 42 to prevent the cover 64 from separating from the body 42. Thus, the timer 40 presents a more appealing blend with the existing decor of the room.

Returning to FIG. 2, the user, during use, sets the tappets 62 representing the times at which the appliance plugged into the receptacle 54 turns “on” and “off”. To set the time at which the appliance should turn “on”, the user moves the appropriate tappet 62 to the “on” position, for example, toward the end wall 44. To set a time at which the appliance should turn “off”, the user moves the appropriate tappet 62 to the “off” position, for example, toward the end wall 46. If an additional switching time is desired, additional pairs of “on” and “off” tappets 62 may be moved within the setting ring 58 at appropriate locations to the “on” and “off” positions.

Thus, the tappets 62 are located around the body 42 appropriately positioned within the setting ring 58 at the desired switching times, i.e., the times at which the user wishes the appliance plugged into the receptacle 54 to turn “on” and “off”. Accordingly, the tappets 62 are moved at positions representing the desired times within the setting ring 58. For example, a first tappet 62 representing 2:00 p.m. and a second tappet 62 representing 9:00 p.m. are moved to activate and deactivate the controlled appliance. Other tappets 62 may also be moved to represent other activating and deactivating times.

After setting the switching times, the timer 40 is plugged into a conventional wall socket 30 and the controlled appliance is plugged into the receptacle 54. The manual override 56 may be set to “ON” or “OFF” corresponding to the desired state of the receptacle 54. The manual override 56 may be appropriately marked with indicia, e.g., “ON” and “OFF” to facilitate determining the state of the timer 40.

The setting ring 58 is connected to a conventional clock mechanism internal of the body 42. The clock mechanism causes the setting ring 58 to make one full rotation for a predetermined period of time such as every 24 hours or once a week. As the setting ring 58 rotates, the tappets 62 open or close the power to the receptacle 54.

In particular, in a known fashion, AC power from the wall socket 30 discharges to a coil which creates an oscillating magnetic field in a field plate forcing a rotor to turn. The rotor in turn drives a reduction gear train which rotates the setting ring 58 once per day or once per week. At the perimeter of the setting ring 58 are the tappets 62 which cause a “trip wheel” to rotate about a shaft. The trip wheel is keyed for corotation into a cam wherein electrical contacts ride on the cam. Thus, the cam is designed such that the rotation of the cam within the trip wheel opens or closes the contacts in accordance with the settings of the tappets 62.

From the foregoing, it will be observed that numerous modifications and variations can be effected without departing from the true spirit and scope of the novel concept of the present invention. It is to be understood that no limitation with respect to the specific apparatus illustrated herein is intended or should be inferred. It is, of course, intended to cover by the appended claims all such modifications as fall within the scope of the claims.

I claim:

1. A timer, comprising:
a body, the body having a length with a first end wall and a second end wall;
a setting ring, the setting ring being engaged with a portion of the body and being rotatable around an axis of rotation extending through the body; and
a plurality of tappets, the plurality of tappets being positioned around and engaged with the setting ring, wherein the plurality of tappets move between a first position and a second position within the setting ring in a direction parallel to the axis of rotation.

2. The timer according to claim 1, wherein the axis of rotation is parallel to the length of the body.

3. The timer according to claim 1, wherein the axis of rotation is substantially perpendicular to the first and second end walls.

4. The timer according to claim 1, wherein the tappets move parallel to the length of the body.

5. The timer according to claim 1., further comprising a plug extending perpendicular to the axis of rotation.

6. The timer according to claim 5, wherein the setting ring rotates in a plane parallel to a direction that the plug extends.

7. The timer according to claim 1, further comprising a receptacle, wherein the setting ring surrounds the receptacle.

8. The timer according to claim 1, further comprising a cover positioned around the body.

9. The timer according to claim 8, wherein the cover is movable to a position obscuring the setting ring.

10. The timer according to claim 1, wherein the tappets surround a portion of the body.

11. The timer according to claim 1, wherein the first position is toward the first end wall.

12. The timer according to claim 1, wherein the second position is toward the second end wall.

13. A timer, comprising:
a body, the body having a length with a first end wall, a second end wall and a receptacle;
a setting ring, the setting ring being engaged with a portion of the body and being rotatable around an axis of rotation which is parallel to and extending through the body, the setting ring being positioned to surround the receptacle; and
a plurality of tappets, the plurality of tappets being positioned around and engaged with the setting ring, each of the tappets being moveable in the setting ring in a direction parallel to the axis of rotation.

14. The timer according to claim 13, wherein the axis of rotation is generally perpendicular to the first end wall and the second end wall.

15. The timer according to claim 13, further comprising a plug extending perpendicular to the axis of rotation.

16. The timer according to claim 15, wherein the setting ring rotates in a plane parallel to a direction that the plug extends.

17. The timer, according to claim 13 further comprising a cover positioned around the body.

18. The timer according to claim 17 wherein the cover is movable to a position obscuring the setting ring.

19. A timer, comprising:
a body, the body having a length with a first end wall and a second end wall;
a setting ring, the setting ring being engaged with a portion of the body and being rotatable around an axis of rotation which is parallel to the length of the body and perpendicular to the first end wall and the second end wall;
a plurality of tappets, the plurality of tappets being positioned around and engaged with the setting ring, each of the tappets being movable in the setting ring in a direction parallel to the axis of rotation; and
a cover positioned around the body wherein the cover is movable to a position relative to the setting ring to obscure the setting ring.

20. The timer according to claim 19, further comprising a plug extending perpendicular to the axis of rotation.

21. The timer according to claim 20, wherein the setting ring rotates in a plane parallel to a direction that the plug extends.

22. The timer according to claim 19, further comprising a light positioned on the body.
